(19) United States
(12) Patent Application Publication
(10) Pub. No.: US 2026/0201828 A1
(43) Pub. Date: Jul. 16, 2026

(54) WALL-GUIDED SPARK ASSISTANCE FOR COLD OPERATIONS IN GASOLINE COMPRESSION IGNITION ENGINES

(71) Applicant: SAUDI ARABIAN OIL COMPANY, Dhahran (SA)

(72) Inventors: Le Zhao, Farmington HIlls, MI (US); Yu Zhang, Carmel, IN (US); Anqi Zhang, Canton, MI (US); Yuanjiang Pei, Novi, MI (US)

(73) Assignee: ARAMCO SERVICES COMPANY, Houston, TX (US)

(21) Appl. No.: 19/022,229

(22) Filed: Jan. 15, 2025

(51) Int. Cl. F02B 11/00; F02B 23/06; F02B 23/10

(52) U.S. Cl. CPC F02B 11/00; F02B 23/0624; F02B 23/0669; F02B 2023/108

(57) ABSTRACT

A wall-guided spark assisted gasoline compression ignition engine for facilitating a combustion reaction during cold conditions includes cylinders, pistons, spark plugs, and fuel injectors. Each cylinder forms a containment boundary for a corresponding combustion reaction. Each piston is positioned in a corresponding cylinder, and each piston includes a piston bowl formed with a step-lipped design. The step-lipped design includes a protrusion positioned between an upper cavity and a lower cavity that are each concentric with a center of a corresponding piston bowl. Each spark plug generates an ignition arc in the corresponding cylinder, thereby initiating the corresponding combustion reaction. Each fuel injector injects fuel into the corresponding cylinder, and the injected fuel is combined with air to form an air-fuel mixture. Each piston bowl at least partially facilitates a swirling motion of the air-fuel mixture and directs a spray plume of the air-fuel mixture toward a corresponding spark plug.

### BACKGROUND

Gasoline compression ignition (GCI) engines operate by compressing a gasoline-air mixture until it auto-ignites within a combustion chamber, where the combustion of the gasoline-air mixture forces movement of pistons and a crankshaft within the engine. A typical GCI engine includes multiple cylinders defining the combustion chambers within an engine block.

Spark assisted ignition is a method used in GCI engines, where a spark plug is employed to initiate combustion when conditions are not sufficient for compression ignition alone. The spark plug may generate an ignition arc, or spark, such that combustion is created by sparking the gasoline-air mixture in the combustion chamber of the engine. This allows the engine to maintain consistent ignition, by using spark assistance when necessary, while still operating primarily under compression ignition.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A wall-guided spark assisted gasoline compression ignition engine for facilitating a combustion reaction during cold conditions includes cylinders, pistons, spark plugs, and fuel injectors. Each cylinder forms a containment boundary for a corresponding combustion reaction. Each piston is positioned in a corresponding cylinder, and each piston includes a piston bowl formed with a step-lipped design. The step-lipped design includes a protrusion positioned between an upper cavity and a lower cavity that are each concentric with a center of a corresponding piston bowl. Each spark plug generates an ignition arc in the corresponding cylinder, thereby initiating the corresponding combustion reaction. Each fuel injector injects fuel into the corresponding cylinder, and the injected fuel is combined with air to form an air-fuel mixture. Each piston bowl at least partially facilitates a swirling motion of the air-fuel mixture and directs a spray plume of the air-fuel mixture toward a corresponding spark plug.

A method for operating a wall-guided spark assisted gasoline compression engine during cold operations includes containing combustion reactions in cylinders, where each cylinder forms a containment boundary for a corresponding combustion reaction. The method further includes positioning pistons in the cylinders, where each piston includes a piston bowl formed with a step-lipped design, where the step-lipped design includes a protrusion positioned between an upper cavity and a lower cavity that are each concentric with a center of a corresponding piston bowl. In addition, the method includes injecting fuel into the cylinders with fuel injectors, where each fuel injector injects the fuel into a corresponding cylinder, and where the injected fuel is combined with air to form an air-fuel mixture. Furthermore, the method includes generating ignition arcs with spark plugs, where each spark plug is positioned to generate an ignition arc in the corresponding cylinder, thereby initiating the corresponding combustion reaction. Additionally, the method includes facilitating a swirling motion of the air-fuel mixture in each cylinder at least partially with the piston bowl of the piston positioned in the corresponding cylinder. Finally, the method includes directing, in each cylinder, a spray plume of the air-fuel mixture toward a corresponding spark plug with the piston bowl of the piston positioned in the corresponding cylinder.

Other aspects and advantages of the claimed subject matter will be apparent from the following description and appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIGS. 1A-1D depict phases of an engine cycle in accordance with one or more embodiments disclosed herein.

FIGS. 2A and 2B depict a piston bowl from different views in accordance with one or more embodiments disclosed herein.

FIG. 3 depicts a block diagram of the components associated with the engine in accordance with one or more embodiments disclosed herein.

FIGS. 4A-4D depict a visualization of a process for wall-guided air-fuel mixture formation within a piston bowl in accordance with one or more embodiments disclosed herein.

FIG. 5 depicts a graph demonstrating the relationship between pressure and rate of heat release as a function of a crankshaft angle in accordance with one or more embodiments disclosed herein.

FIG. 6 depicts a flowchart of a process for operating the engine in accordance with one or more embodiments disclosed herein.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In addition, throughout the application, the terms “upper” and “lower” may be used to describe the position of an element in an engine as described herein. In this regard, the phrase “upper” refers to a component that is located above a corresponding “lower” component, and vice versa.

In general, one or more embodiments of the present invention are directed to a gasoline compression ignition (GCI) combustion engine with a wall-guided spark assistance technique in order to create an effective cold start combustion strategy. The effective cold start combustion strategy includes utilizing a spark plug to initiate ignition of the air-fuel mixture present in the combustion chamber, and to further utilize a unique piston bowl design configured to distribute and guide the air-fuel mixture towards the spark plug. By guiding the air-fuel mixture towards a spark plug during cold start conditions, the proposed design ensures reliable ignition and stable GCI engine combustion for all operating conditions.

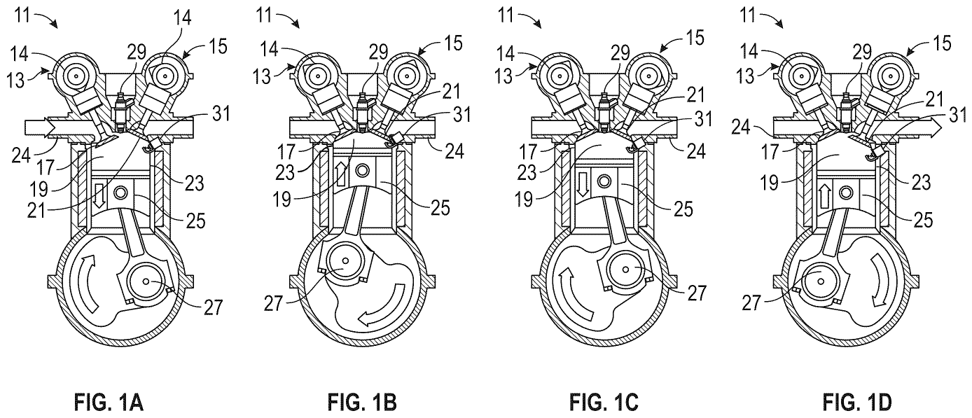

FIGS. 1A-1D illustrate a four-step process for creating a combustion reaction performed by an engine 11. Specifically, FIG. 1A relates to an intake phase of the combustion reaction, whereas FIG. 1B relates to a compression phase, FIG. 1C relates to a power phase, and FIG. 1D corresponds to an exhaust phase of an engine cycle. FIGS. 1A-1D each depict a point in time during the operation of a single cylinder 23, such that FIGS. 1A-1D may be replicated for each cylinder 23 per engine cycle.

As shown in FIG. 1A, the engine 11 includes a plurality of fuel injectors 29, which are fluidly connected to a fuel rail (not shown). A corresponding fuel injector 29 of the plurality of fuel injectors 29 is embodied, for example, as an electromagnetically actuated pintle valve that serves to selectively pass fuel from a storage container, such as a fuel tank (not shown), into a corresponding cylinder 23 of a plurality of cylinder 23. The fuel injected into the cylinder 23 may comprise a low-cetane gasoline fuel, where the term “low” implies a cetane number less than 40 (inclusive). It will be appreciated to a person having ordinary skill in the art that the definition of “low” may vary according to the contemplated engine structure and configuration. Cetane number is an indicator of the combustion characteristics of a fuel, specifically associated with the ignition quality of the fuel under compression. Cetane numbers are most typically associated with diesel fuels, which typically have a cetane number of approximately 44. On the other hand, a low-cetane gasoline fuel may have, for example, a cetane number of approximately 20, and the research octane number may range from, but is not limited to, 60-92 (inclusive). The use of low-cetane gasoline fuel in a GCI engine leads to a longer ignition delay compared to the use of diesel fuel, such that the low-cetane gasoline fuel allows more time for air-fuel mixing before combustion occurs. This improved mixing may contribute to more homogenous combustion and reduce nitrogen oxide emissions.

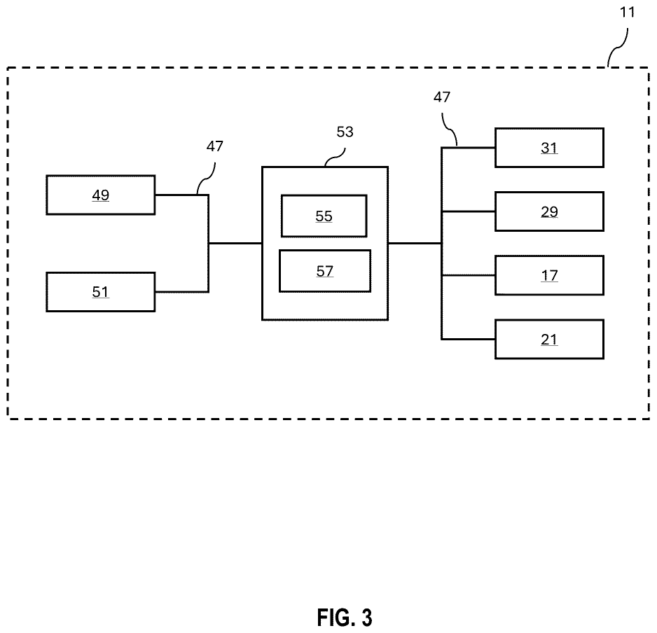

In addition, the engine 11 includes a plurality of spark plugs 31 configured to assist in the ignition of an air-fuel mixture by generating an ignition arc in a corresponding cylinder 23. A corresponding spark plug 31 of the plurality of spark plugs may be disposed on the cylinder head 24 within a corresponding cylinder 23 of the plurality of cylinders 23. The actuation of the fuel injector 29 and the spark plug 31 is controlled by an electronic control unit (ECU) (e.g., FIG. 3) as discussed further below. Further, the ECU coordinates the operation of each fuel injector 29 and spark plug 31 in tandem with a plurality of other fuel injectors 29 and spark plugs 31 in order to form a cohesive operation that includes multiple combustion reactions occurring in quick succession.

The engine 11 further includes an intake camshaft 13 and an exhaust camshaft 15. In general, the camshafts 13 and 15 are formed as metal rods that serve to mechanically control the operation of the engine 11 by regulating the introduction and removal of various fluids from the cylinders 23. The camshafts 13 and 15 are aligned so as to extend across each of the cylinders 23, such that a single intake camshaft 13 coordinates the intake operations and a single exhaust camshaft 15 coordinates the exhaust operations of the cylinders 23. Each camshaft includes a plurality of lobes 14 that actuate a corresponding valve of a corresponding cylinder 23. The corresponding valves include, for example, an intake valve 17 that actuates based on the motion of the intake camshaft 13 and an exhaust valve 21 that actuates based on the motion of the exhaust camshaft 15.

In the context of FIGS. 1A-1D, the intake valve 17 and exhaust valve 21 are configured to facilitate the introduction and removal of gases from the combustion chamber 19. In particular, the intake valve 17 is configured to allow air to enter the combustion chamber 19 prior to a combustion reaction. Conversely, the exhaust valve 21 is configured to allow combusted air-fuel mixture to exit the combustion chamber 19 following the combustion reaction. The intake valve 17 and the exhaust valve 21 may be formed, for example, from metal and are typically formed with a conical profile that is attached to a tappet.

For its part, the cylinder 23 forms a containment boundary for the combustion reaction in conjunction with a piston 25 that is actuated by the combustion reaction. The usable volume within the containment boundary is depicted as a combustion chamber 19, which represents the volume in the engine 11 created by the piston 25 and the cylinder 23. The piston 25 is a solid body, typically formed of metal, that is thrust downwards by the combustion reaction.

The piston 25 is mechanically coupled to a crankshaft 27, which performs multiple functions discussed below. As a first function, the crankshaft 27 serves to couple the combined actuation of the pistons 25 into a single motion, such that the crankshaft 27 forms a power output shaft of the engine 11. As a second function, the crankshaft 27 provides a point to measure output rotations of the engine 11, such that the position of the crankshaft is related to the timing of operations of the engine 11 as a whole.

With the components of FIGS. 1A-1D discussed above, the below paragraphs related to FIGS. 1A-1D discuss time-dependent actions taken by various components of the engine 11 to create the combustion reaction. In relation to FIG. 1A specifically, the intake valve 17 is opened by the intake camshaft 13 to allow intake air to pass from an intake manifold (not shown) to the cylinder 23. This is further facilitated by the crankshaft 27 being actuated by other combustion reactions in other cylinders 23, causing the piston 25 of FIG. 1A to thrust downward and creating a negative pressure in the combustion chamber 19. Accordingly, FIG. 1A corresponds to the intake phase of a four stroke combustion process, as FIG. 1A depicts the intake air entering the cylinder 23. Once the gas mixture is disposed in the combustion chamber 19, the process continues as depicted in FIG. 1B.

In FIG. 1B, a small burst of fuel is sprayed into the combustion chamber 19 by way of the fuel injector 29, and the piston 25 is forced upwards by the crankshaft 27 to compress the air-fuel mixture inside of the combustion chamber 19, which is referred to as the “compression” phase of the four stroke combustion process. Similar to the actuation of the piston 25 in FIG. 1A, the crankshaft 27 actuates the piston 25 in FIG. 1B using power siphoned from other power strokes of other cylinders 23. The process of actuating the piston 25 in FIG. 1B is completed when the piston 25 reaches the height of its motion, which is referred to as Top Dead Center (TDC) due to the cylinder 23 being at the top of its travel path. It is noted that the engine 11 is configured to operate with a compression ratio of 16 or greater, inclusive. At this point, the process transitions to FIG. 1C, which represents the power phase of the four stroke combustion process.

In FIG. 1C, the power phase occurs after the compression phase as the piston 25 is actuated downwards. Due to the relatively rapid compression of the intake air during the compression phase depicted in FIG. 1B, the combustion chamber 19 may have an internal temperature above the combustion temperature of the injected fuel. Thus, the fuel injected during the compression phase may auto-ignite upon coming into contact with the heated intake air, and the subsequent rapid expansion may cause the piston 25 to actuate downward and transfer its motion to the crankshaft 27. The power phase depicted in FIG. 1C is complete when the piston 25 has substantially reached its lowermost point of motion, which is referred to as Bottom Dead Center (BDC) herein.

It is noted, however, that during cold start conditions, the internal temperature of the combustion chamber 19 may not initially reach a temperature above the combustion temperature of the injected fuel. Therefore, the spark plug 31 is used to assist in the combustion of the air-fuel mixture by way of generating an ignition arc leading to the ignition of the air-fuel mixture. The ECU (e.g., FIG. 3), as discussed further below, is configured to operate the engine 11 in a gasoline compression ignition mode when the engine temperature is above or equal to a predetermined threshold, and the ECU (e.g., FIG. 3) is further configured to operate the engine 11 in a spark assisted ignition mode when the engine temperature is below the predetermined threshold.

Once the power phase of FIG. 1C is complete the process continues to FIG. 1D, which depicts the exhaust phase of the four stroke combustion process. During the exhaust phase, the exhaust camshaft 15 actuates an exhaust valve 21, which creates a fluid passageway between the cylinder 23 and the exhaust manifold (not shown). The piston 25 is actuated by the crankshaft 27 during this time to actively force exhaust gases (i.e., combusted air-fuel mixture) from the cylinders 23 by reducing the volume of the combustion chamber 19. Once the exhaust gases have been removed from the cylinder 23, the four stroke combustion process is complete, and restarts with the intake phase depicted in FIG. 1A.

The above process provides a brief overview of a four stroke combustion reaction process. However, and as discussed further below, the engine 11 is configured by the ECU (e.g., FIG. 3) to operate according to two separate modes: a gasoline compression ignition mode and a spark assisted ignition mode. The gasoline compression ignition mode relates to the above discussed four stroke process. On the other hand, the spark assisted ignition mode involves additionally operating the spark plug 31 during the compression phase, and the spark assisted ignition mode may typically occur during cold start conditions.

Cold start conditions for an engine 11 may occur when the engine 11 has been at rest for a prolonged period, typically resulting in an engine 11 being at an ambient temperature rather than at optimal operating temperatures as defined by a manufacturer. The temperature of the engine may be determined by way of a temperature sensor (e.g., FIG. 3). Once the engine 11 has reached a sufficient operating temperature that eclipses a predetermined threshold, the engine 11 is considered “warmed up” and operates in the gasoline compression ignition mode.

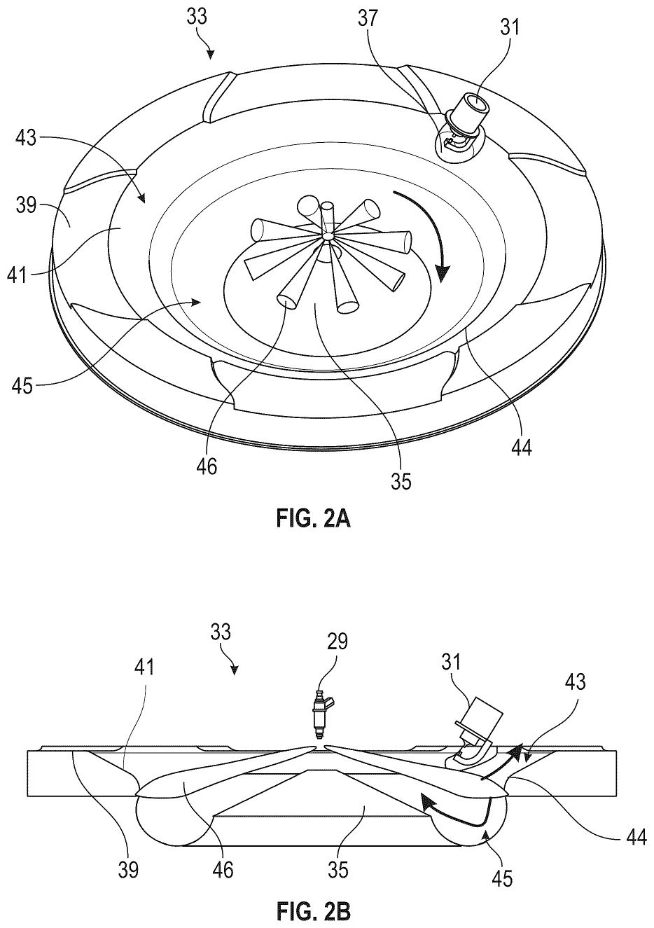

Turning to FIGS. 2A and 2B, FIG. 2A depicts an isometric top view of a piston bowl 33 in accordance with one or more embodiments of the inventions. The piston bowl 33 is disposed on a top of a corresponding piston 25 of a plurality of pistons 25. The piston bowl 33 is at least partially configured to facilitate a swirling motion of the air-fuel mixture and direct a spray plume of the air-fuel mixture toward a spark plug 31. In particular, the swirling motion is achieved through a combination of the flow of gas (i.e., air) through an intake port (not shown) controlled by an intake valve 17, the actuation of the piston 25 itself, and the geometry of the piston bowl 33.

The geometry of the piston bowl 33 comprises an outer annular surface 39 occupying a horizontal plane, a sloped surface 41 contiguous with the outer annular surface 39, a conical section 35, an upper cavity 43, and a lower cavity 45. The sloped surface 41 descends from the outer annular surface 39 toward a center of a corresponding piston bowl 33 such that an upper cavity 43 is formed in a space between the sloped surface 41 and the horizontal plane. The conical section 35 comprises a flat surface that descends from the center of the piston bowl 33 to the lower cavity 45, and the lower cavity 45 comprises a semicircular groove.

In addition, the piston bowl 33 is formed with a step-lipped design, where the step-lipped design comprises a protrusion 44 positioned between the upper cavity 43 and the lower cavity 45 that are concentric with the center of the piston bowl 33. Thus, overall, the piston bowl 33 has a bowl shaped design with a coaxial conical section 35 that distributes the spray plume 46 to the cavities 43, 45.

The piston bowl 33 further comprises a recess 37 configured to accommodate the spark plug 31, such that the piston bowl may not come into direct contact with the spark plug 31 during the four stroke combustion reaction process. It is noted that the spark plug 31 may be side-mounted to a cylinder 23, while the fuel injector 29 may be centrally mounted above a corresponding conical section 35 of the piston bowl 33. The fuel injector 29 may comprise, for example, at least eight orifices, where fuel is configured to travel through the at least eight orifices such that the fuel is injected onto the center of the conical section 35 with eight distinct exit angles. The injected fuel is combined with air to form an air-fuel mixture. The conical section 35 is positioned in relation to the fuel injector 29 such that the conical section 35 directs the air-fuel mixture toward a corresponding protrusion 44 positioned between the lower cavity 45 and the upper cavity 43. A spray plume 46 of the fuel as it is injected from the fuel injector 29 onto the conical section 35 is shown in FIGS. 2A and 2B.

The geometry of the piston bowl 33 is formed such that the air-fuel mixture is dispersed and guided toward the spark plug 31 in order to initiate and assist in ignition of the air-fuel mixture during cold start conditions (i.e., spark assisted ignition mode). The air-fuel mixture has a swirl ratio of approximately 1. As is commonly known in the art, the term “swirl ratio” refers to the geometry of a vortex chamber, and mathematically represents the ratio of angular momentum to radial momentum of a fluid. The spark plug 31 may be positioned at a predefined distance, e.g., approximately 50 millimeters, from the centrally located fuel injector 29 along the horizontal plane, and protruding a predefined distance, e.g., approximately 5 millimeters, from the cylinder head 24 toward the recess 37 disposed on the piston bowl 33.

Turning to FIG. 2B, FIG. 2B depicts a side-cut view of the piston bowl 33. The side-cut view of the piston bowl 33 shows that as the fuel is injected from the centrally mounted fuel injector 29, the fuel is dispersed from the conical section 35, combining with air to form an air-fuel mixture, and the spray plume 46 of the air-fuel mixture is directed toward the protrusion 44 positioned between the lower cavity 45 and the upper cavity 43.

When the air-fuel mixture comes in contact with the protrusion 44, the spray plume 46 is partitioned, and a portion of the spray plume 46 is redirected towards the spark plug 31. The remaining portion of the spray plume 46 is directed by the protrusion 44 towards the semicircular groove within the lower cavity 45. In this way, the step-lipped design of the piston bowl 33 and the in-cylinder swirl motion encourages further mixing of the fuel with the intake air in order to create a more evenly distributed air-fuel mixture, and facilitate an even combustion within the combustion chamber 19. The air-fuel mixture in the lower cavity 45 undergoes further mixing and swirling until the remaining air-fuel mixture is combusted.

Turning to FIG. 3, FIG. 3 shows a block diagram of various hardware components connected to the Electronic Control Unit (ECU) 53. As discussed above, the ECU 53 operates to control whether the engine 11 is operated in the gasoline compression ignition mode or the spark assisted ignition mode. Thus, FIG. 3 depicts hardware components that feed information to or receive instructions from the ECU 53 in order to enable an operating mode transition. In this regard, components depicted in FIG. 3 as being connected to the left hand side of the ECU 53 represent sensors that feed information to the ECU 53. On the other hand, components connected to the right hand side of the ECU 53 represent actuatable components that are controlled by the ECU 53 to physically facilitate the operating mode transition. The various components of FIG. 3 are interconnected by way of a wiring harness 47, which may be a bundle of wires that form electrical pathways between the ECU 53 and the various sensor and actuatable components.

For its part, the ECU 53 includes a memory 55 and a processor 57 configured to receive and interpret readings from the sensors. The processor 57 is formed by one or more processors, integrated circuits, microprocessors, or equivalent computing structures that can serve to execute computer readable instructions stored on the memory 55. Thus, the memory 55 includes a non-transitory storage medium such as flash memory, a Hard Disk Drive (HDD), a solid state drive (SSD), a combination thereof, or equivalent storage devices. In relation to the invention as described herein, the memory 55 stores computer readable instructions, executed by the processor 57, that relate to controlling the engine to operate in the gasoline compression ignition mode, to operate in the spark assisted ignition mode, and to transition between the engine operating modes.

As shown in FIG. 3, the sensors may include, but are not limited to, a crankshaft position sensor 49 and a temperature sensor 51. The crankshaft position sensor 49 may, for example, be embodied as a rotary encoder that captures the current rotation angle and rotation speed of the crankshaft 27. The temperature sensor 51 may, for example, be embodied as a thermostat, and measures the temperature of coolant in the engine 11 in order to determine the temperature of the engine 11. The position of the crankshaft 27 may be utilized by the ECU 53 in order to coordinate the timing of various operations of the combustion process.

As one example of the ECU 53 controlling the engine 11, based upon the position of the crankshaft 27 and the associated signal received from the crankshaft position sensor 49, the ECU 53 determines the timing for operating the fuel injectors 29. As a second example, the ECU 53 determines whether the engine should be operated in the gasoline compression ignition mode or the spark assisted ignition mode based upon the temperature of the engine 11 from the temperature sensor 51, and actuates the spark plug 31 according to the determined operating mode.

In accordance with one or more embodiments of the invention, cold start conditions may comprise an ambient temperature and/or engine 11 temperature of less than 25 degrees Celsius. However, it will be appreciated by a person having ordinary skill in the art that the temperature for determining cold start conditions is not limited to less than 25 degrees Celsius, and may vary according to a manufacturer's or operator's discretion. Cold start conditions may occur when the engine 11 has been at rest for a prolonged period, typically resulting in an engine 11 being at an ambient temperature rather than at optimal operating temperatures. In this way, the spark assisted ignition mode, which utilizes a spark plug 31 to initiate and assist in the ignition of the air-fuel mixture in the combustion chamber 19 when the internal temperature of the combustion chamber 19 is less than the temperature required for combustion of the injected fuel, may be helpful in assisting the engine 11 to facilitate a combustion reaction while transitioning from cold start conditions to warm operating conditions.

Based upon the readings from the sensors (i.e., crankshaft position sensor 49 and temperature sensor 51), the ECU 53 controls the operation of, but not limited to, the spark plug 31, the fuel injector 29, the intake valve 17, and the exhaust valve 21 in a cohesive manner. Collectively, the cohesive operation of the spark plug 31, fuel injector 29, intake valve 17, and exhaust valve 21 by the ECU 53 serves to facilitate the transition between engine operating modes, as well as to facilitate a combustion reaction within the engine 11.

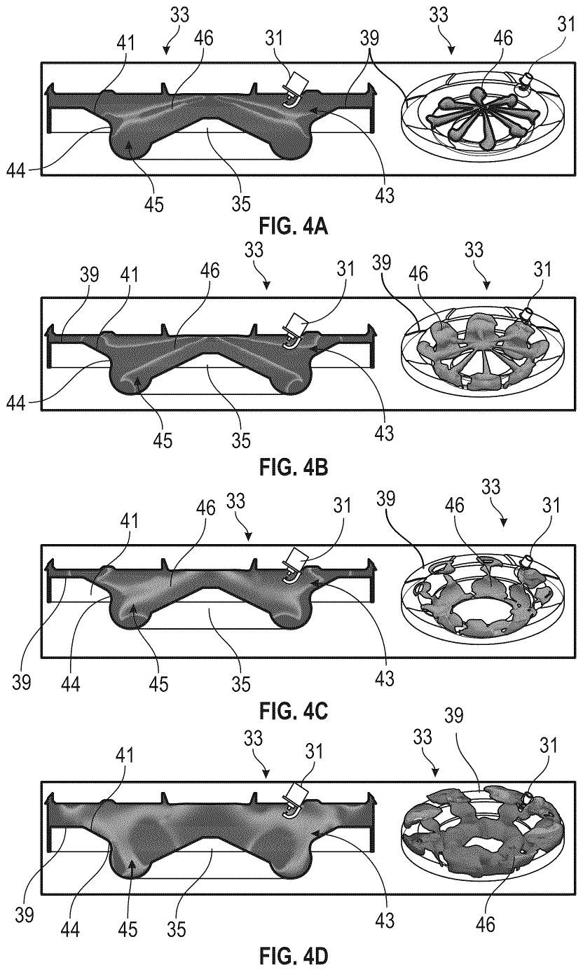

Turning to FIGS. 4A-4D, FIG. 4A depicts the dispersion of fuel within the piston bowl 33 when the fuel is initially injected from a fuel injector 29. The spray plume 46 is dispersed by the conical section 35 in the center of the piston bowl 33 and directed toward the protrusion 44 positioned between the lower cavity 45 and the upper cavity 43. FIGS. 4A-4D each contain two views of the piston bowl 33. The first view depicts a side cut view of the piston bowl 33 while the second view depicts an orthogonal top view of the piston bowl comprising at least eight spray plumes 46 that are injected from the centrally mounted fuel injector 29 comprising at least eight orifices.

Turning to FIG. 4B, FIG. 4B depicts the spray plume 46 after being directed toward the protrusion 44 positioned between the lower cavity 45 and the upper cavity 43. The spray plume 46 of the air-fuel mixture is shown as dispersing both toward the upper cavity 43 and the lower cavity 45 after coming in contact with the protrusion 44. The portion of the spray plume 46 dispersed toward the upper cavity 43 is pushed along the sloped surface 41 and toward the spark plug 31. On the other hand, the portion of the spray plume 46 dispersed toward the lower cavity 45 enters a semicircular groove and swirls throughout the piston bowl 33.

Turning to FIG. 4C, the spark plug 31 initiates ignition of the spray plume 46 of air-fuel mixture. The spray plume 46, as a result of shape of the piston bowl 33 and the swirling motion, is guided toward the spark plug 31 and dispersed throughout the piston bowl. It can be seen in FIG. 4C that the majority of the spray plume 46 is located along the sloped surface 41 near the spark plug 31 and along the semicircular groove of the lower cavity 45.

Turning to FIG. 4D, a majority of the spray plume 46 of air-fuel mixture has been combusted within the piston bowl 33. After the initial ignition of the spray plume 46 nearest the spark plug 31 as shown in FIG. 4C, the combustion reaction of the air-fuel mixture rapidly spreads to the remaining air-fuel mixture. The combination of the step-lipped design of the piston bowl 33 and the swirling of the air-fuel mixture in the piston bowl 33 encourages the distribution of air-fuel mixture throughout the piston bowl 33 and combustion chamber 19. In this way, the design of the piston bowl 33 and the spark assisted ignition mode of the engine ensures reliable and stable ignition of the air-fuel mixture present in the combustion chamber 19, even during cold start conditions when operating in a gasoline compression ignition mode may be insufficient to combust the air-fuel mixture present in the combustion chamber 19.

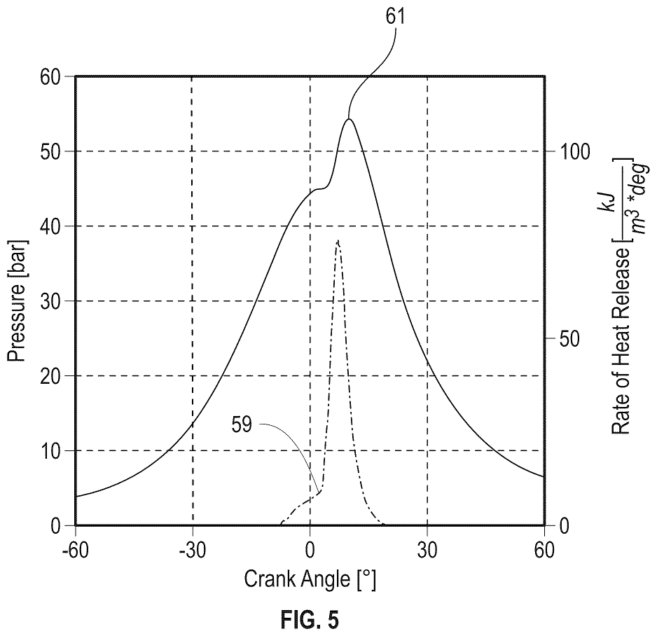

Turning to FIG. 5, FIG. 5 depicts a graph showing the relationship between the pressure and rate of heat release during the combustion reaction as a result of the angle of the crankshaft 27 angle. Units of crankshaft angle are used to describe the x-axis of the graph, where 0 degrees is representative of the crankshaft 27 at Top Dead Center (TDC). TDC occurs during the compression phase of the four stroke combustion process when the piston reaches the peak height of its travel path. The compression phase, as described above, includes compressing the air-fuel mixture within the combustion chamber 19 by actuating the piston 25 to decrease the volume of the combustion chamber 19. As the volume of the combustion chamber 19 decreases, the pressure increases. In addition, as a result of the increase in pressure while the total volume of air-fuel mixture remains constant, the temperature of the combustion chamber increases as well.

This process is shown in FIG. 5, such that at a crankshaft angle of −60 degrees from TDC, the pressure is relatively low at approximately 5 bar. However, as the crankshaft angle approaches 0 degrees (i.e., at TDC), the combustion chamber pressure 61 increases to approximately 45 bar. At the same time, while the piston 25 is approaching TDC and undergoing the compression phase, the temperature of the combustion chamber 19 is increasing. This is shown at approximately-10 degrees from TDC when the rate of heat release 59 begins to increase.

After the piston 25 has reached TDC, the combustion chamber pressure 61 reaches an initial peak at approximately 5 degrees from TDC, where the rate of heat release 59 sharply rises to approximately 75

$$\frac{kilo joules}{{meters}^{3} * d e g r e e s} ( \frac{kJ}{{m}^{3} * deg} ) .$$

As the rate of heat release 59 reaches its peak at approximately 10 degrees from TDC, the combustion chamber pressure 61 further increases as a result of the increased rate of heat release 59. The combustion chamber pressure 61 reaches a new peak of approximately 55 bar at approximately 15 degrees from TDC. As the crankshaft angle continues to increase, the combustion chamber pressure 61 and the rate of heat release 59 decrease until the cycle repeats again.

It is noted that the initial peak of the combustion chamber pressure 61 at 45 bar may occur during the compression phase of the four stroke combustion process, while the peak of the rate of heat release 59 and the second peak of the combustion chamber pressure 61 may occur during the power phase of the four stroke combustion process. It is further noted that from approximately-10 degrees from TDC to approximately 5 degrees from TDC when the rate of heat release 59 stays relatively low, spark assisted ignition is occurring in the combustion chamber 19 such that a spark plug 31 is initiating the combustion reaction and thus flame propagation. As the rate of heat release sharply increases from approximately 5 degrees from TDC to approximately 15 degrees from TDC, auto-ignition of the air-fuel mixture may occur due to an internal temperature of the combustion chamber 19 being above the combustion temperature of the air-fuel mixture. The graph of FIG. 5 is representative of transitioning from cold to warm operating conditions, such that the engine is being operated in a spark assistance ignition mode.

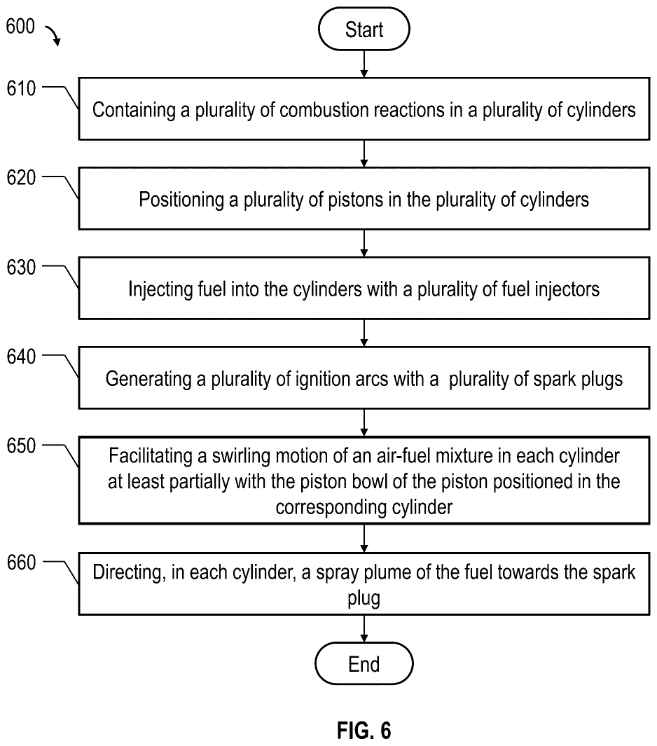

Turning to FIG. 6, FIG. 6 depicts a method 600 for the operation of the engine 11 during cold start conditions in accordance with one or more embodiments of the invention. While the various blocks in FIG. 6 are presented and described sequentially, one of ordinary skill in the art will appreciate that some or all of the blocks may be executed in parallel and/or iteratively. The blocks may encompass multiple actions and/or multiple blocks may be performed in the same physical action. Furthermore, the blocks may be performed actively or passively.

The method of FIG. 6 initiates with Step 610, which includes containing a plurality of combustion reactions in a plurality of cylinders 23. Each cylinder 23 forms a containment boundary for a corresponding combustion reaction. Further, the engine 11 is operated with a compression ratio of 16 or greater, inclusive.

Step 620 includes positioning a plurality of pistons 25 in the plurality of cylinders 23. Each piston 25 of the plurality of pistons 25 has a piston bowl 33 formed with a step-lipped design. Each piston bowl 33 is formed with a geometry comprising an outer annular surface 39 occupying a horizontal plane, a sloped surface 41 contiguous with the outer annular surface 39, a conical section 35, a lower cavity 45, and an upper cavity 43. The sloped surface 41 descends from the outer annular surface 39 toward a center of the piston bowl 33 such that the upper cavity 43 is formed in a space between the sloped surface 41 and the horizontal plane. The conical section 35 comprises a flat surface that descends from the center of the piston bowl 33 to the lower cavity 45, where the lower cavity 45 comprises a semicircular groove. Further, the step-lipped design of the piston bowl 33 comprises a protrusion 44 positioned between the upper cavity 43 and the lower cavity 45 that are concentric with the center of the piston bowl 33.

In Step 630, fuel is injected into the cylinders 23 with a plurality of fuel injectors 29, where each fuel injector 29 of the plurality of fuel injectors 29 is configured to inject fuel into a corresponding cylinder 23 of the plurality of cylinders 23, and the injected fuel is combined with air to form an air-fuel mixture. Each fuel injector 29 is centrally mounted above the center of the piston bowl 33, and the air-fuel mixture is directed toward the protrusion 44 positioned between the upper cavity 43 and the lower cavity 45. The air-fuel mixture may comprise a low-cetane gasoline fuel, where the term “low” implies a cetane number less than 40 (inclusive), for example. It will be appreciated to a person having ordinary skill in the art that the definition of “low” may vary according to the contemplated engine structure and configuration. The use of low-cetane gasoline fuel in a GCI engine leads to a longer ignition delay compared to the use of diesel fuel, such that the low-cetane gasoline fuel allows more time for air-fuel mixing before combustion occurs. This improved mixing may contribute to more homogenous combustion and reduce nitrogen oxide emissions.

Step 640 includes generating a plurality of ignition arcs with a plurality of spark plugs 31. Each spark plug 31 of the plurality of spark plugs 31 is positioned to generate an ignition arc in a corresponding cylinder 23, thereby initiating a corresponding combustion reaction. In addition, each spark plug 31 of the plurality of spark plugs 31 is side-mounted to an inner wall of each corresponding cylinder. The ECU 53 receives and interprets the temperature of the engine 11 via a temperature sensor 51, such that the ECU 53 may operate the engine in one of a gasoline compression ignition mode or a spark assisted ignition mode.

The ECU 53 operates the engine 11 in the spark assisted ignition mode when the engine temperature is below a predetermined threshold (i.e., 25 degrees Celsius, cold start conditions), and the ECU 53 operates the engine 11 in gasoline compression ignition mode when the engine temperature is above or equal to the predetermined threshold. The spark assisted ignition mode utilizes the spark plug 31 to initiate and assist in the ignition of the air-fuel mixture in the combustion chamber 19, while the gasoline compression ignition mode auto-ignites the air-fuel mixture without the need for the spark plug 31.

Step 650 includes facilitating a swirling motion of the air-fuel mixture in each cylinder 23 at least partially with the piston bowl 33 of the piston 25 positioned in the corresponding cylinder 23. The in-cylinder swirl motion encourages mixing of the injected fuel with the intake air in order to create an evenly distributed air-fuel mixture to facilitate an even combustion within the combustion chamber 19. The air-fuel mixture has a swirl ratio of approximately 1.

Finally, Step 660 includes directing, in each cylinder 23, a spray plume 46 of the air-fuel mixture towards the spark plug with the piston bowl 33 of the piston 25 positioned in the corresponding cylinder 23. The air-fuel mixture that is directed toward the protrusion 44 between the upper cavity 43 and the lower cavity 45, which splits the spray plume 46 of the air-fuel mixture such that the air-fuel mixture is redirected toward the spark plug 31 and the semicircular groove of the lower cavity 45. The air-fuel mixture in the lower cavity 45 undergoes further mixing and swirling until the remaining air-fuel mixture is combusted in the combustion chamber 19.

Although only a few example embodiments have been described in detail above, those skilled in the art will readily appreciate that many modifications are possible in the example embodiments without materially departing from this invention. In addition, many modifications will be appreciated by those skilled in the art to adapt a particular component, situation, or material to embodiments of the disclosure without departing from the essential scope thereof. Accordingly, all such modifications are intended to be included within the scope of this disclosure as defined in the following claims. Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. An engine comprising:
a plurality of cylinders, each cylinder of the plurality of cylinders being configured to form a containment boundary for a corresponding combustion reaction;
a plurality of pistons, each piston being positioned in a corresponding cylinder and comprising a piston bowl formed with a step-lipped design,
a plurality of spark plugs, each spark plug of the plurality of spark plugs being configured to generate an ignition arc in the corresponding cylinder, thereby initiating the corresponding combustion reaction;
a plurality of fuel injectors, where each fuel injector is configured to inject fuel into the corresponding cylinder of the plurality of cylinders, and where the injected fuel is combined with air to form an air-fuel mixture;
wherein each piston bowl is at least partially configured to facilitate a swirling motion of the air-fuel mixture and direct a spray plume of the air-fuel mixture toward a corresponding spark plug of the plurality of spark plugs,
wherein the step-lipped design comprises a protrusion positioned between an upper cavity and a lower cavity that are each concentric with a center of a corresponding piston bowl.

2. The engine of claim 1, wherein the fuel injected into the plurality of cylinders comprises a low-cetane gasoline fuel.

3. The engine of claim 1, wherein a geometry of the piston bowl comprises:
an outer annular surface occupying a horizontal plane;
a sloped surface contiguous with the outer annular surface, wherein the sloped surface descends from the outer annular surface towards the center of the piston bowl such that the upper cavity is formed in a space between the sloped surface and the horizontal plane;
a conical section comprising a flat surface that descends from the center of the piston bowl to the lower cavity,
wherein the lower cavity comprises a semicircular groove.

4. The engine of claim 3, wherein the sloped surface of each piston bowl comprises a recess configured to accommodate the corresponding spark plug of the plurality of spark plugs.

5. The engine of claim 3, wherein a corresponding fuel injector of the plurality of fuel injectors is centrally mounted above a corresponding conical section of each piston bowl.

6. The engine of claim 5, wherein each fuel injector of the plurality of fuel injectors comprises at least eight orifices configured to inject the fuel onto a center of the corresponding conical section of each piston bowl.

7. The engine of claim 6, wherein the corresponding conical section of each piston bowl is positioned in relation to the corresponding fuel injector such that the corresponding conical section of each piston bowl directs the air-fuel mixture towards a corresponding protrusion positioned between the lower cavity and the upper cavity.

8. The engine of claim 7, wherein the air-fuel mixture has a swirl ratio of one.

9. The engine of claim 1, wherein the engine operates with a compression ratio of 16 or greater, inclusive.

10. The engine of claim 1, further comprising a temperature sensor configured to output an engine temperature and an electronic control unit (ECU), the ECU comprising a memory and a processor configured to receive and interpret the engine temperature.

11. The engine of claim 10, wherein the ECU is configured to operate the engine in a gasoline compression ignition mode when the engine temperature is above or equal to a predetermined threshold, and the ECU is further configured to operate the engine in a spark assisted ignition mode when the engine temperature is below the predetermined threshold.

12. A method of operating an engine, comprising:
containing a plurality of combustion reactions in a plurality of cylinders, where each cylinder is configured to form a containment boundary for a corresponding combustion reaction;
positioning a plurality of pistons in the plurality of cylinders, where each piston of the plurality of pistons comprises a piston bowl formed with a step-lipped design;
injecting fuel into the plurality of cylinders with a plurality of fuel injectors, where each fuel injector of the plurality of fuel injectors is configured to inject the fuel into a corresponding cylinder of the plurality of cylinders, and where the injected fuel is combined with air to form an air-fuel mixture;
generating a plurality of ignition arcs with a plurality of spark plugs, where each spark plug of the plurality of spark plugs is positioned to generate an ignition arc in the corresponding cylinder, thereby initiating the corresponding combustion reaction;
facilitating a swirling motion of the air-fuel mixture in each cylinder at least partially with the piston bowl of the piston positioned in the corresponding cylinder;
directing, in each cylinder, a spray plume of the air-fuel mixture toward a corresponding spark plug of the plurality of spark plugs with the piston bowl of the piston positioned in the corresponding cylinder;
wherein the step-lipped design comprises a protrusion positioned between an upper cavity and a lower cavity that are each concentric with a center of a corresponding piston bowl.

13. The method of claim 12, further comprising mounting each fuel injector of the plurality of fuel injectors above the center of each piston bowl.

14. The method of claim 13, wherein the air-fuel mixture is directed toward a corresponding protrusion positioned between the lower cavity and the upper cavity of each piston bowl.

15. The method of claim 12, further comprising operating the engine with a compression ratio of 16 or greater, inclusive.

16. The method of claim 12, further comprising outputting an engine temperature via a temperature sensor.

17. The method of claim 16, further comprising receiving and interpreting the engine temperature via an electronic control unit (ECU).

18. The method of claim 17, further comprising operating, via the ECU, the engine in a gasoline compression ignition mode when the engine temperature is above or equal to a predetermined threshold.

19. The method of claim 18, further comprising operating, via the ECU, the engine in a spark assisted ignition mode when the engine temperature is below the predetermined threshold.

20. The method of claim 12, further comprising side-mounting the corresponding spark plug of the plurality of spark plugs to an inner wall of the corresponding cylinder of the plurality of cylinders.
